(19) United States
(12) Patent Application Publication
(10) Pub. No.: US 2025/0349325 A1
(43) Pub. Date: Nov. 13, 2025

(54) HIGH VOLTAGE GENERATION BLOCK WITH TRIMMING CIRCUIT

(71) Applicant: Silicon Storage Technology, Inc., San Jose, CA (US)

(72) Inventors: Hieu Van Tran, San Jose, CA (US); Duc Nguyen, Ho Chi Minh (VN); Hien Pham, Ho Chi Minh (VN); Thuan Vu, San Jose, CA (US); Anh Ly, San Jose, CA (US); Stanley Hong, San Jose, CA (US)

(21) Appl. No.: 18/782,018

(22) Filed: Jul. 23, 2024

Related U.S. Application Data
(60) Provisional application No. 63/645,073, filed on May 9, 2024.

(51) Int. Cl. G11B 33/12; G11B 33/14

(52) U.S. Cl. CPC G11B 33/122; G11B 33/144

(57) ABSTRACT

In one example, a high voltage generation block comprises a temperature sensor to sense an operating temperature and output a temperature output, a trim circuit to receive a trim enable circuit and the temperature output and to generate oscillator trim bits, a charge pump oscillator to generate an oscillating signal in response to the oscillator trim bits and a feedback signal, a charge pump to receive the oscillating signal and to generate a pumped voltage, and a charge pump regulator to receive the pumped voltage and to generate the feedback signal and a high voltage output.

### PRIORITY CLAIM

This application claims priority to U.S. Provisional Patent Application No. 63/645,073, filed on May 9, 2024, and titled, “High Voltage Generation Block With Trimming Circuit,” which is incorporated by reference herein.

### FIELD OF THE INVENTION

An improved high voltage generation block for use in programming and erasing non-volatile memory cells is disclosed.

### BACKGROUND OF THE INVENTION

Non-volatile memories are well known. For example, U.S. Pat. No. 5,029,130 (“the '130 patent”), which is incorporated herein by reference, discloses an array of split gate non-volatile memory cells, which are a type of flash memory cells. Such a memory cell 110 is shown in FIG. 1. Each memory cell 110 includes source region 14 and drain region 16 formed in semiconductor substrate 12, with channel region 18 there between. Floating gate 20 is formed over and insulated from (and controls the conductivity of) a first portion of the channel region 18, and over a portion of the source region 14. Word line terminal 22 (which is typically coupled to a word line) has a first portion that is disposed over and insulated from (and controls the conductivity of) a second portion of the channel region 18, and a second portion that extends up and over the floating gate 20. The floating gate 20 and word line terminal 22 are insulated from the substrate 12 by a gate oxide. Bitline 24 is coupled to drain region 16.

Memory cell 110 is erased (where electrons are removed from the floating gate) by placing a high positive voltage on the word line terminal 22, which causes electrons on the floating gate 20 to tunnel through the intermediate insulation from the floating gate 20 to the word line terminal 22 via Fowler-Nordheim (FN) tunneling.

Memory cell 110 is programmed by source side injection (SSI) with hot electrons (where electrons are placed on the floating gate) by placing a positive voltage on the word line terminal 22, and a positive voltage on the source region 14. Electron current will flow from the drain region 16 towards the source region 14. The electrons will accelerate and become heated when they reach the gap between the word line terminal 22 and the floating gate 20. Some of the heated electrons will be injected through the gate oxide onto the floating gate 20 due to the attractive electrostatic force from the floating gate 20.

Memory cell 110 is read by placing positive read voltages on the drain region 16 and word line terminal 22 (which turns on the portion of the channel region 18 under the word line terminal). If the floating gate 20 is positively charged (i.e., erased of electrons), then the portion of the channel region 18 under the floating gate 20 is turned on as well, and current will flow across the channel region 18, which is sensed as the erased or “1” state. If the floating gate 20 is negatively charged (i.e., programmed with electrons), then the portion of the channel region under the floating gate 20 is mostly or entirely turned off, and current will not flow (or there will be little flow) across the channel region 18, which is sensed as the programmed or “0” state.

Table No. 1 depicts typical voltage and current ranges that can be applied to the terminals of memory cell 110 for performing read, erase, and program operations:

TABLE NO. 1
Operation of Flash Memory Cell 110 of FIG. 1

| | | |
|---|---|---|
| WL | BL | SL |

| | | | | | | |
|---|---|---|---|---|---|---|
| Read | 2-3 | V | 0.6-2 | V | 0 | V |
| Erase | ~11-13 | V | 0 | V | 0 | V |
| Program | 1-2 | V | 10.5-3 | μA | 9-10 | V |

Other split gate memory cell configurations, which are other types of flash memory cells, are known. For example, FIG. 2 depicts a four-gate memory cell 210 comprising source region 14, drain region 16, floating gate 20 over a first portion of channel region 18, a select gate 22 (typically coupled to a word line, WL) over a second portion of the channel region 18, a control gate 28 over the floating gate 20, and an erase gate 30 over the source region 14. This configuration is described in U.S. Pat. No. 6,747,310, which is incorporated herein by reference for all purposes. Here, all gates are non-floating gates except floating gate 20, meaning that they are electrically connected or connectable to a voltage source. Programming is performed by heated electrons from the channel region 18 injecting themselves onto the floating gate 20. Erasing is performed by electrons tunneling from the floating gate 20 to the erase gate 30.

Table No. 2 depicts typical voltage and current ranges that can be applied to the terminals of memory cell 210 for performing read, erase, and program operations:

TABLE NO. 2
Operation of Flash Memory Cell 210 of FIG. 2

| | WL/SG | | BL | | CG | | EG | | SL | |
|---|---|---|---|---|---|---|---|---|---|---|
| Read | 1.0-2 | V | 0.6-2 | V | 0-2.6 | V | 0-2.6 | V | 0 | V |
| Erase | −0.5 V/0 V | | 0 | V | 0 V/−8 V | | 8-12 | V | 0 | V |
| Program | 1 | V | 0.1-1 | μA | 8-11 | V | 4.5-9 | V | 4.5-5 | V |

FIG. 3 depicts a three-gate memory cell 310, which is another type of flash memory cell. Memory cell 310 is identical to the memory cell 210 of FIG. 2 except that memory cell 310 does not have a separate control gate. The erase operation (whereby erasing occurs through use of the erase gate) and read operation are similar to that of the FIG. 2 except there is no control gate bias applied. The programming operation also is done without the control gate bias, and as a result, a higher voltage is applied on the source line during a program operation to compensate for a lack of control gate bias.

Table No. 3 depicts typical voltage and current ranges that can be applied to the terminals of memory cell 310 for performing read, erase, and program operations:

TABLE NO. 3
Operation of Flash Memory Cell 310 of FIG. 3

| | | | |
|---|---|---|---|
| WL/SG | BL | EG | SL |

| | | | | | | | | |
|---|---|---|---|---|---|---|---|---|
| Read | 0.7-2.2 | V | 0.6-2 | V | 0-2.6 | V | 0 | V |

| | | | | | | | |
|---|---|---|---|---|---|---|---|
| Erase | −0.5 V/0 V | 0 | V | 11.5 | V | 0 | V |

| | | | | | | | | |
|---|---|---|---|---|---|---|---|---|
| Program | 1 | V | 0.2-3 | μA | 4.5 | V | 7-9 | V |

FIG. 4 depicts stacked gate memory cell 410, which is another type of flash memory cell. Memory cell 410 is similar to memory cell 110 of FIG. 1, except that floating gate 20 extends over the entire channel region 18, and control gate 22 (which here will be coupled to a word line) extends over floating gate 20, separated by an insulating layer (not shown). The erase is done by FN tunneling of electrons from FG to substrate, programming is by channel hot electron (CHE) injection at region between the channel 18 and the drain region 16, by the electrons flowing from the source region 14 towards to drain region 16 and read operation which is similar to that for memory cell 210 with a higher control gate voltage.

Table No. 4 depicts typical voltage ranges that can be applied to the terminals of memory cell 410 and substrate 12 for performing read, erase, and program operations:

TABLE NO. 4
Operation of Flash Memory Cell 410 of FIG. 4

| | CG | | BL | | SL | Substrate |
|---|---|---|---|---|---|---|
| Read | 2-5 | V | 0.6-2 | V | 0 V | 0 V |
| Erase | −8 to −10 V/0 V | | FLT | | FLT | 8-10 V/15-20 V |
| Program | 8-12 | V | 3-5 | V | 0 V | 0 V |

The methods and means described herein may apply to other non-volatile memory technologies such as FINFET split gate flash or stack gate flash memory, NAND flash, SONOS (silicon-oxide-nitride-oxide-silicon, charge trap in nitride), MONOS (metal-oxide-nitride-oxide-silicon, metal charge trap in nitride), ReRAM (resistive ram), PCM (phase change memory), MRAM (magnetic ram), FeRAM (ferroelectric ram), CT (charge trap) memory, CN (carbon-tube) memory, OTP (bi-level or multi-level one time programmable), and CeRAM (correlated electron ram), without limitation.

FIG. 5 depicts a block diagram of prior art memory system 500. Memory 500 comprises array 501, row decoder 502, high voltage decoder 503, column decoders 504, bit line drivers 505, input circuit 506, output circuit 507, control logic 508, and bias generator 509. Memory system 500 further comprises high voltage generation block 510, which comprises charge pump 511, charge pump regulator 512, and high voltage level generator 513. Memory system 500 further comprises (program/erase, or weight tuning) algorithm controller 514, analog circuitry 515, control engine 516 (that may include special functions such as arithmetic functions, activation functions, embedded microcontroller logic, without limitation), test control logic 517, and SRAM block 518 to store intermediate data such as input data for programming, output data (e.g., from output circuit 507), microcode, test codes, or other data.

Array 501 comprises rows and columns of non-volatile memory cells, such as memory cells 110, 210, 310, or 410 from FIGS. 1-4, respectively.

The input circuit 506 may include circuits such as a DAC (digital to analog converter), DPC (digital to pulses converter, digital to time modulated pulse converter), AAC (analog to analog converter, such as a current to voltage converter, logarithmic converter), PAC (pulse to analog level converter), or any other type of converters. The input circuit 506 may implement one or more of normalization, linear or non-linear up/down scaling functions, or arithmetic functions. The input circuit 506 may implement a temperature compensation function for input levels. The input circuit 506 may implement an activation function such as ReLU or sigmoid. Input circuit 506 may store digital activation data to be applied as or combined with an input signal during a program or read operation. The digital activation data can be stored in registers. Input circuit 506 may comprise circuits to drive the array terminals, such as CG, WL, EG, and SL lines, which may include sample-and-hold circuits and buffers. A DAC can be used to convert digital activation data into an analog input voltage to be applied to the array.

Output circuit 507 may include circuits such as an ITV (current-to-voltage circuit), ADC (analog to digital converter, to convert neuron analog output to digital bits), AAC (analog to analog converter, such as a current to voltage converter, logarithmic converter), APC (analog to pulse(s) converter, analog to time modulated pulse converter), or any other type of converters. Output circuit 507 may convert array outputs into activation data. Output circuit 507 may implement an activation function such as rectified linear activation function (ReLU) or sigmoid. Output circuit 507 may implement one or more of statistic normalization, regularization, up/down scaling/gain functions, statistical rounding, or arithmetic functions (e.g., add, subtract, divide, multiply, shift, log) for neuron outputs. Output circuit 507 may implement a temperature compensation function for neuron outputs or array outputs (such as bitline output) so as to keep power consumption of the array approximately constant over temperature or to improve precision of the array (neuron) outputs such as by keeping the IV slope approximately the same over temperature. Output circuit 507 may comprise registers for storing output data.

Output circuit 507 may include sense amplifiers that are used to convert output data from array 501 into binary digital bits. In one example, there is no input circuit 506, such as in a situation where array 501 is used to store digital data. In another example, output circuit 507 comprises sense amplifiers, such as in a situation where array 501 is used to store digital data and sense amplifiers are used to convert output data from array 501 into binary digital output bits.

A charge pump can be used to generate high voltages for erase and program operations, such as those shown in Table Nos. 1-4 above, from a supply voltage that typically generates a voltage between 1.5-3.0 V. The output voltage of a charge pump can change as operating conditions, such as temperature, change over time.

What is needed is a trimming mechanism and algorithm to adjust a charge pump to provide the desired output voltage as operating conditions change.

### SUMMARY OF THE INVENTION

Examples of trimming mechanisms and methods are disclosed for a charge pump.

In one example, a high voltage generation block comprises a temperature sensor to sense an operating temperature and output a temperature output, a trim circuit to receive a trim enable circuit and the temperature output and to generate oscillator trim bits, a charge pump oscillator to generate an oscillating signal in response to the oscillator trim bits and a feedback signal, a charge pump to receive the oscillating signal and to generate a pumped voltage, and a charge pump regulator to receive the pumped voltage and to generate the feedback signal and a high voltage output.

In another example, a method comprises setting an oscillator trim value to a first initial value, setting a voltage trim value to a second initial value, applying the oscillator trim value and a voltage trim value to a high voltage generation block comprising a charge pump, measuring a voltage output from the charge pump, if the voltage output is not at a target voltage, incrementing the voltage trim value and repeating the applying and measuring, if the voltage output is at the target voltage, setting the oscillator trim value to the voltage trim value, measuring a voltage output from the charge pump, if the voltage output is not at a target voltage, incrementing the oscillator trim value and repeating the applying and measuring steps, and if the voltage output is at the target voltage, storing the voltage trim value and the oscillator trim value.

In another example, a method comprises trimming, using oscillator trim bits, a frequency of a charge pump oscillator until an output of the charge pump receiving an oscillating signal from the charge pump oscillator reaches a peak value, and storing the oscillator trim bits.

### BRIEF DESCRIPTION OF THE DRAWINGS

FIG. 1 depicts a prior art split gate flash memory cell.

FIG. 2 depicts another prior art split gate flash memory cell.

FIG. 3 depicts another prior art split gate flash memory cell.

FIG. 4 depicts another prior art split gate flash memory cell.

FIG. 5 depicts a prior art memory system.

FIG. 6 depicts a graph showing output voltage of a charge pump against the amount of voltage trimming.

FIG. 7 depicts a graph showing output voltage of a charge pump against the amount of oscillator trimming.

FIG. 8 depicts a high voltage generation block with voltage trimming.

FIG. 9 depicts a high voltage generation block with oscillator trimming.

FIG. 10 depicts the high voltage generation block of FIG. 9 with a trim configuration circuit.

FIGS. 11A, 11B, and 11C depicts trim configuration methods.

FIG. 12 depicts a trim data population method.

FIG. 13 depicts a program or erase method.

FIG. 14 depicts a charge pump.

FIG. 15 depicts a charge pump oscillator.

FIG. 16 depicts a charge pump regulator.

FIG. 17 depicts a temperature sensor.

FIG. 18 depicts a temperature sensor.

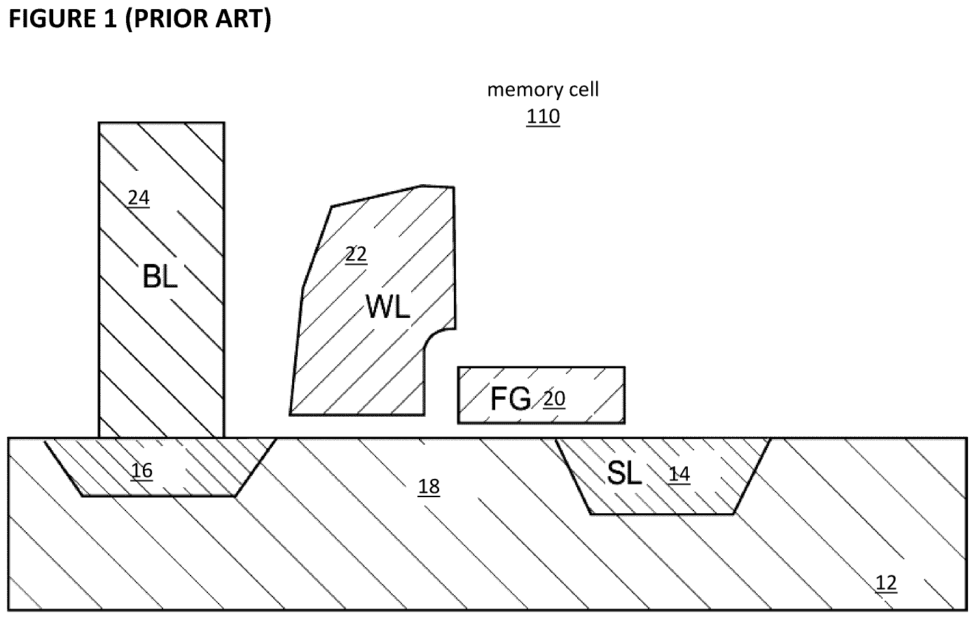

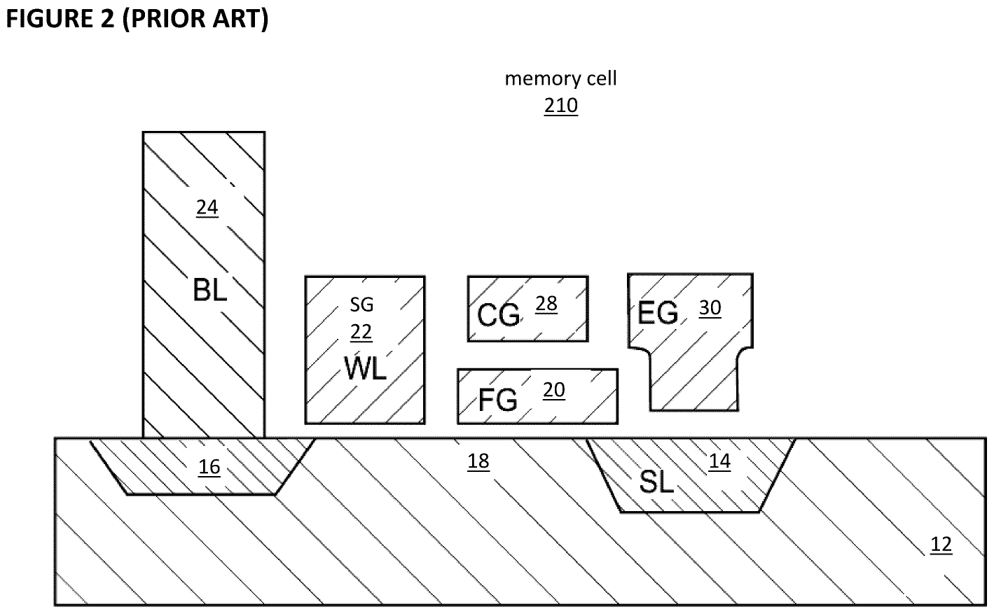

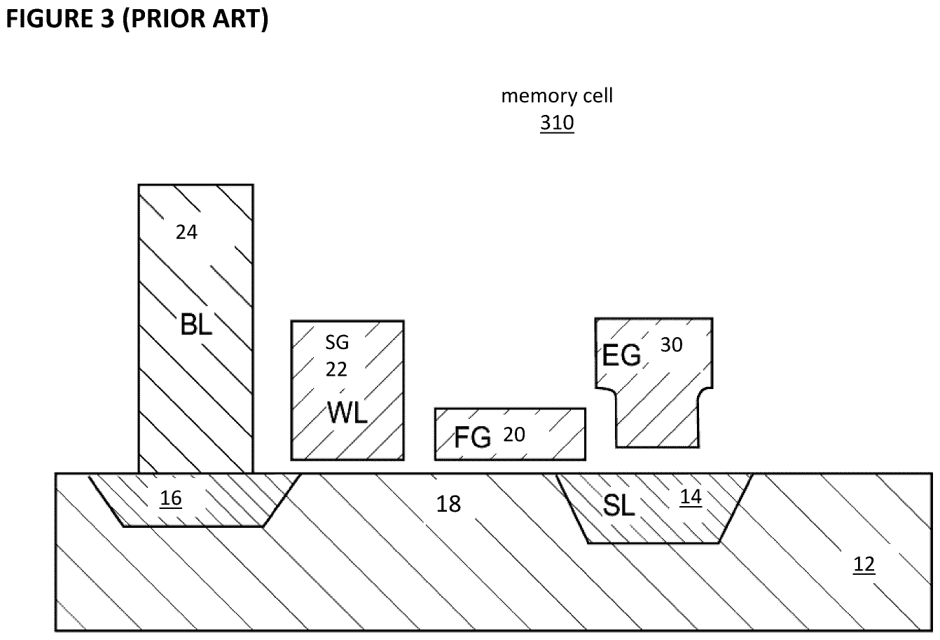

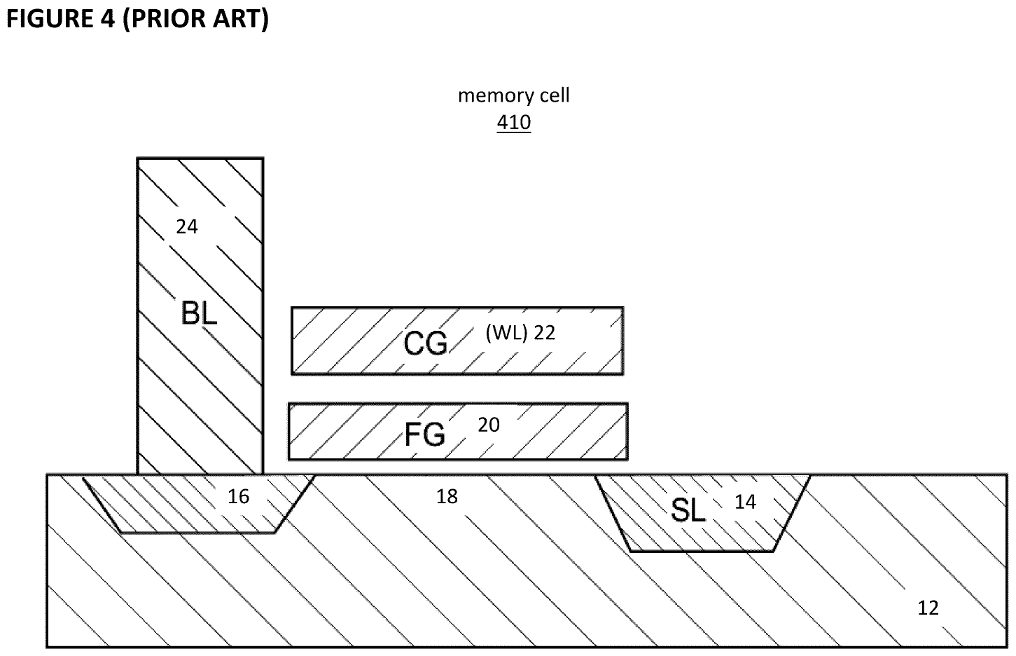

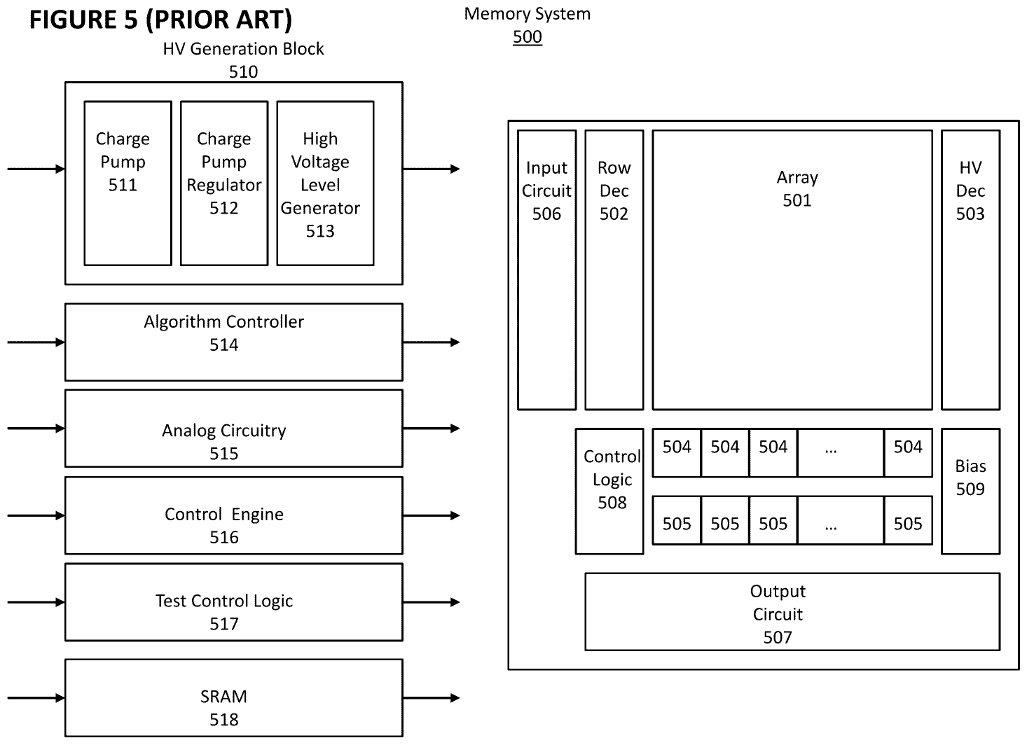

### DETAILED DESCRIPTION OF THE INVENTION

Examples are described herein for performing one or more of voltage trimming and oscillator frequency trimming on a charge pump.

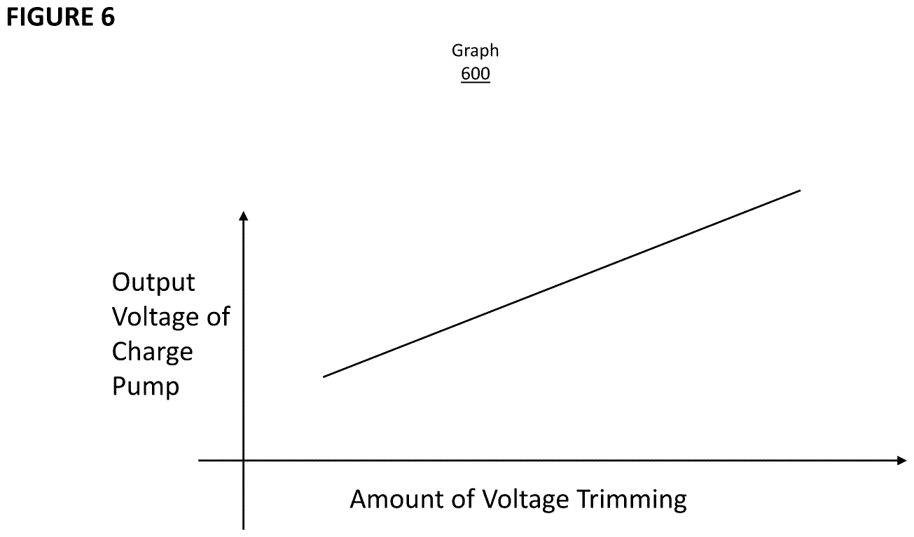

FIG. 6 depicts an example of the effect of performing voltage trimming on a charge pump. Graph 600 depicts the output voltage of a charge pump as a function of the amount of voltage trimming performed. Graph 600 shows a linear relationship. The trimming is performed using trim bits, fuse bits, test bits, or another mechanism that are used to control a voltage level generator.

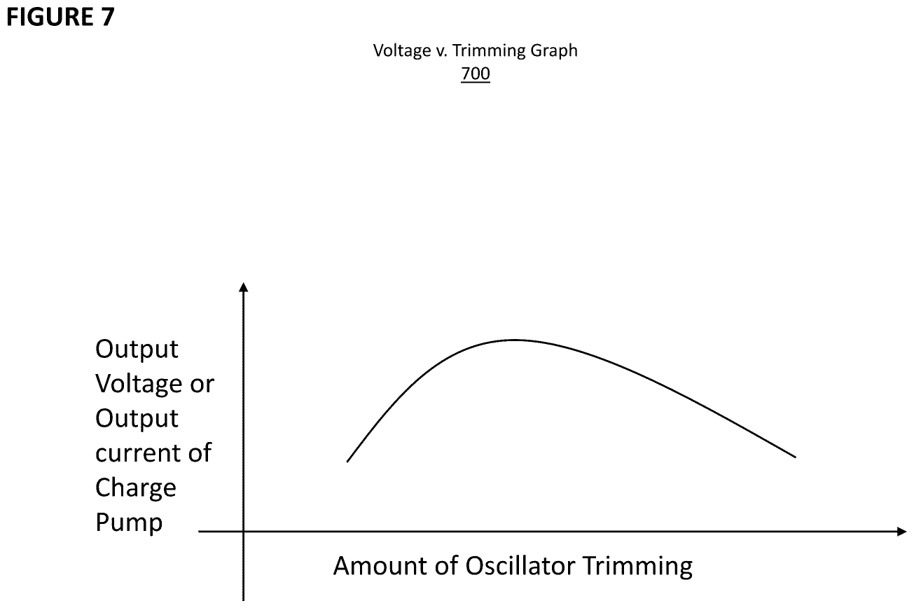

FIG. 7 depicts an example of the effect of performing oscillator trimming on a charge pump, where the frequency of an oscillator signal used by the charge pump is trimmed. Graph 700 depicts the output voltage of a charge pump as a function of the amount of oscillator trimming performed, where the frequency increases from left to right. Graph 700 shows a non-linear relationship. The trimming is performed using trim bits, fuse bits, test bits, or another mechanism that are used to control the frequency of a pump oscillator.

The output voltage and the output current of a chare pump is dependent on the pump oscillator frequency F. In one example of a charge pump, IOUT=C*V*F2, where IOUT is the pump output current, V is the supply voltage, C is the pump capacitance for one stage, and F is the pump oscillator frequency. Hence as the frequency increases, the pump output current increases. However, if the frequency becomes too high, the output current actually decreases due to the charge pump circuit not being able to respond fast enough and the equation contained above no longer applies. Hence, the pump loses efficiency at that high frequency. Therefore, there is an optimal oscillator frequency that results in optimal charge pump performance in terms of output current and output voltage. This optimal oscillator frequency varies over process, temperature, and voltage (PVT), and it therefore is desirable to be able to trim the oscillator frequency as conditions change.

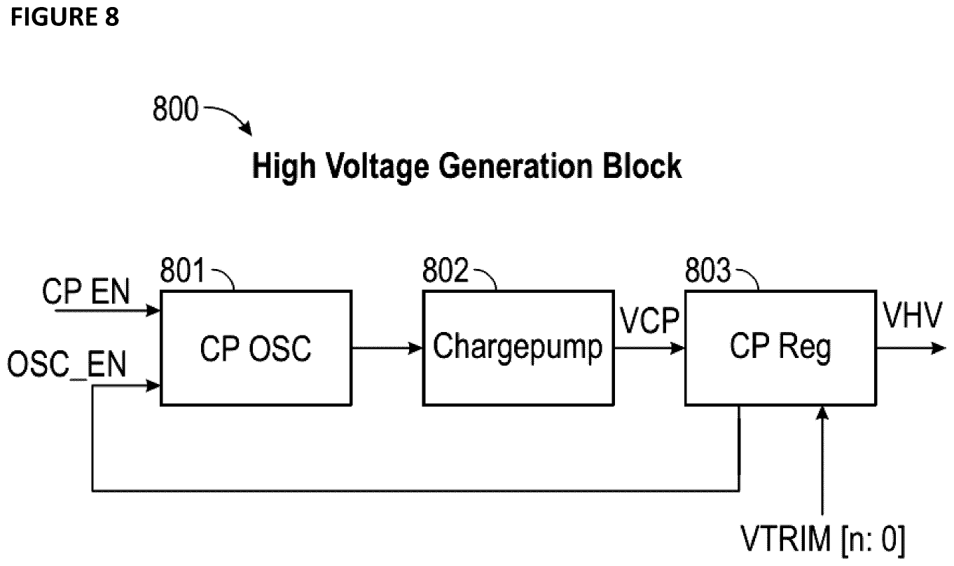

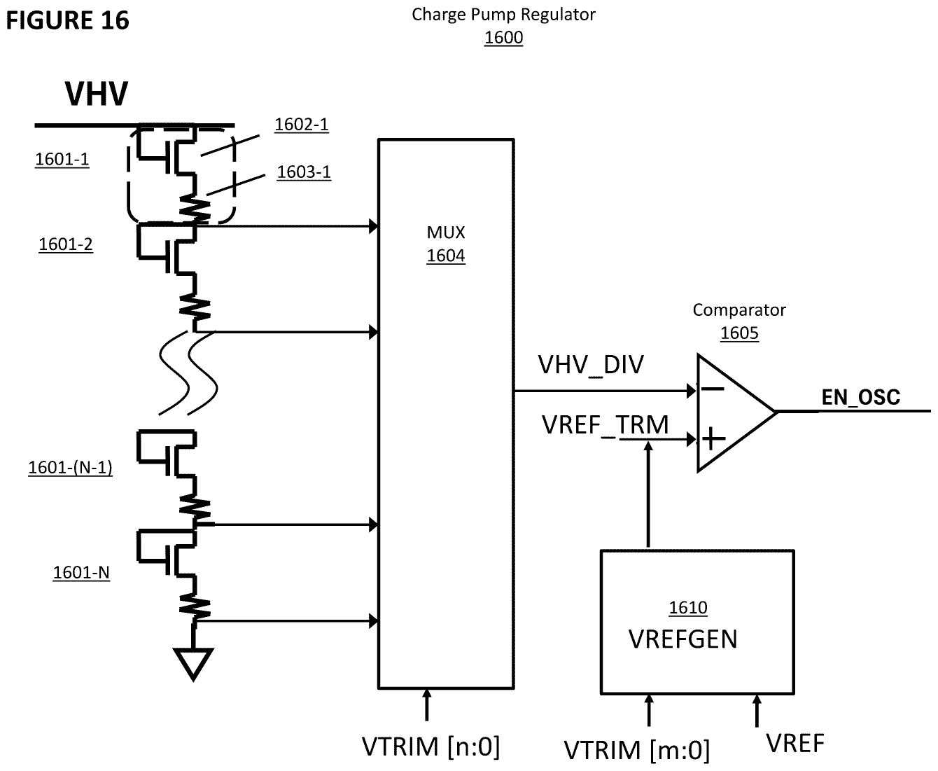

FIG. 8 depicts high voltage generation block 800 that performs voltage trimming through voltage trim bits VTRIM[n: 0]. High voltage generation block 800 comprises charge pump oscillator 801, charge pump 802, and charge pump regulator 803. Charge pump oscillator receives a charge pump enable signal, CP_EN, and an oscillator enable signal, OSC_EN. When CP_EN and OSC_EN are asserted, charge pump oscillator 801 will output a clock signal at a certain frequency. Charge pump 802 receives the clock signal and pumps up a voltage using the clock signal, where a pumping action occurs with each high state in the clock signal. Charge pump 802 outputs a pumped voltage, VCP, which is received by charge pump regulator 803. Charge pump regulator 803 also receives voltage trim bits, VTRIM[n:0] which contains n+1 bits. The voltage trim bits are used to adjust the pumped voltage, VCP, to generate the high voltage output, VHV. An example of such a voltage trimming operation is shown in FIG. 16, below. Charge pump regulator 803 provides OSC_EN to chip oscillator 801.

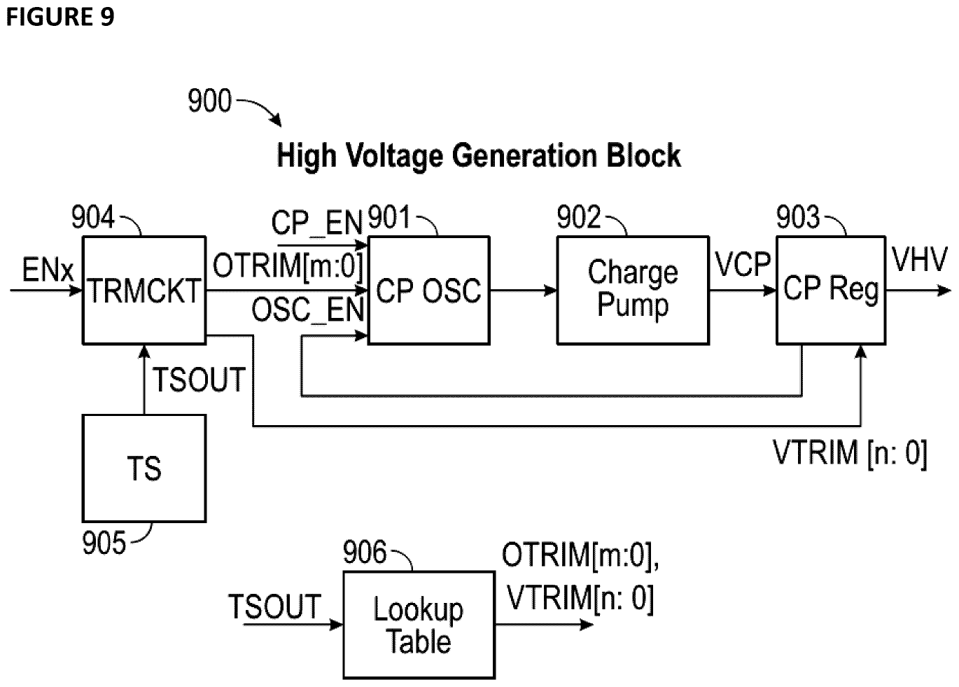

FIG. 9 depicts high voltage generation block 900 that performs voltage level trimming and oscillator frequency trimming through voltage trim bits VTRIM[n:0] and OTRIM[m:0], respectively. High voltage generation block 900 comprises charge pump oscillator 901, charge pump 902, charge pump regulator 903, trim circuit 904 (which contains lookup table 906), and temperature sensor 905. Trim circuit 904 receives an enable signal, ENx, as well as temperature data, TSOUT, from temperature sensor 905. TSOUT is used to retrieve OTRIM[m:0] and VTRIM[n:0] from lookup table 906. When ENx is asserted, trim circuit 904 provides oscillator trim bits, OTRIM[m:0] which contains m+1 bits, in response to temperature data, TSOUT, to charge pump oscillator, which also receives a charge pump enable signal, CP_EN, and an oscillator enable signal, OSC_EN. When CP_EN and OSC_EN are asserted, charge pump oscillator 901 will output a clock signal at a certain voltage and frequency, where the frequency is determined by OTRIM[m:0]. Charge pump 902 receives the clock signal and pumps up a voltage using the clock signal, where a pumping action occurs with each high state in the clock signal. Charge pump 902 outputs a pumped, high voltage signal, VCP, which is received by charge pump regulator 903. Charge pump regulator 903 also receives voltage trim bits, VTRIM[n:0], which contains n+1 bits. Charge pump regulator 903 provides an output voltage, VHV, and a feedback signal, OSC_EN, to charge pump oscillator 901.

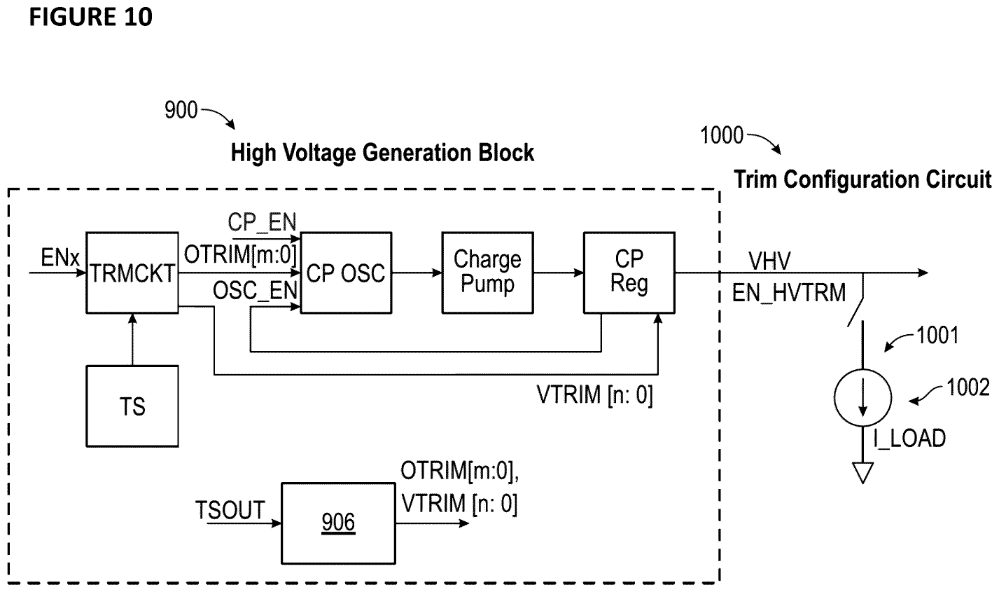

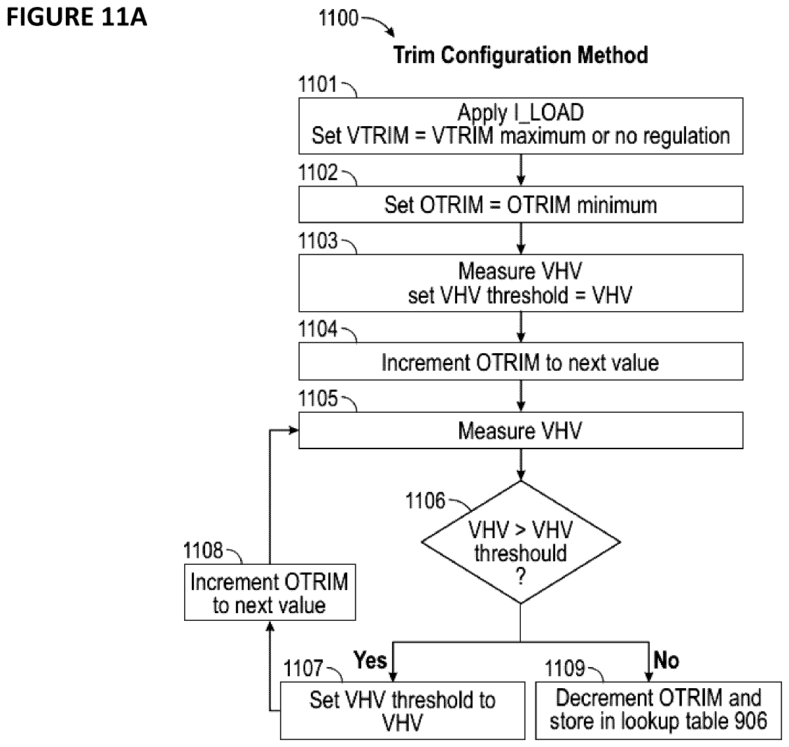

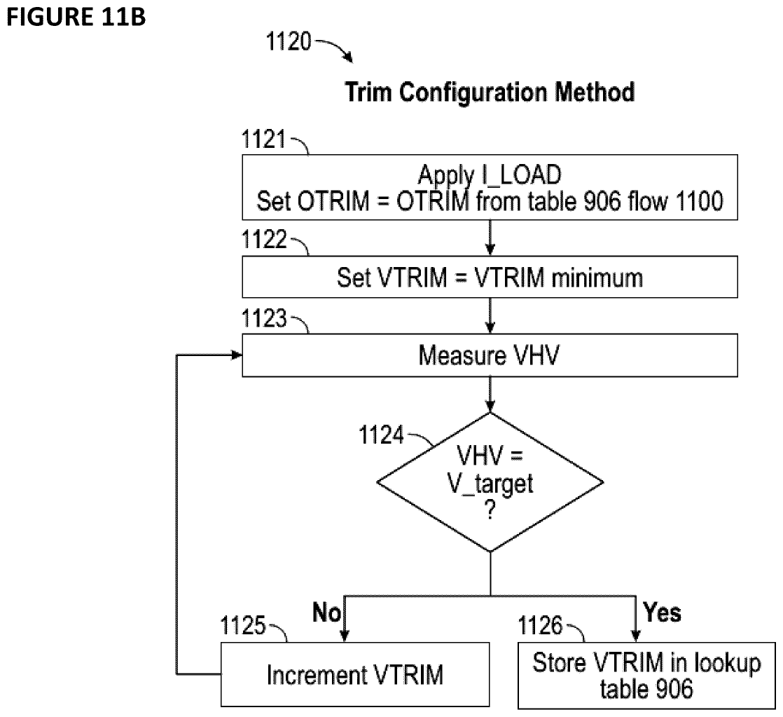

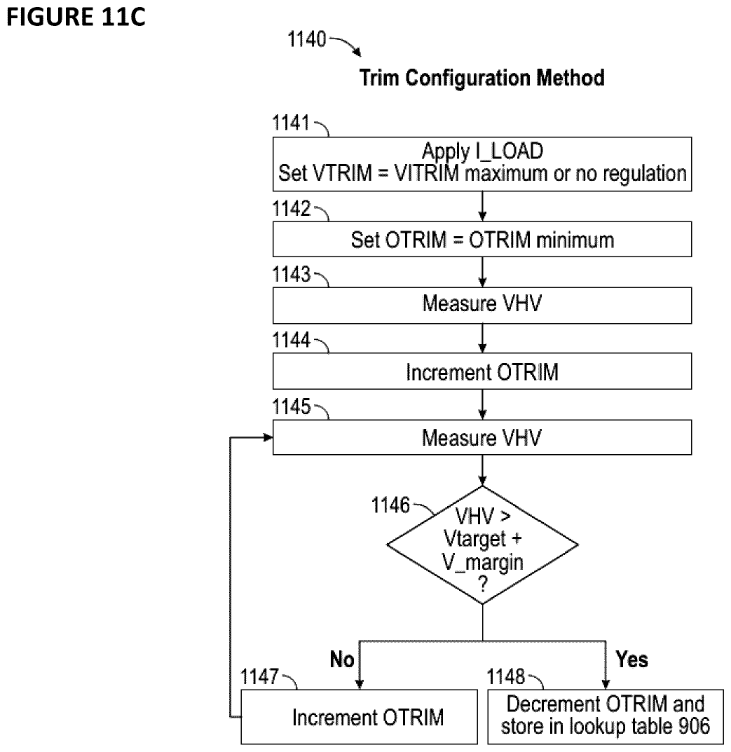

FIG. 10 depicts trim configuration circuit 1000 that is used in conjunction with high voltage generation block 900 to determine settings for OTRIM and VTRIM to store in lookup table 906. Trim configuration circuit 1000 comprises switch 1001 enables by EN_HVTRM1, and current source 1002 that draws a target current, I_LOAD. EN_HVTRM is enabled when it is desired to perform trim configuration. Current source 1002 can be a bias current source, or it also can be an actual array drawing current during a programming operation, where the drawn current will equal (Iprog*N+Imargin), where Iprog is a programming current, N is the number of cells being programmed, and Imargin is a current margin added to that measured current. OTRIM and VTRIM will then be adjusted in the manner described in FIG. 11A, 11B, or 11C, below, and the output voltage VHV is compared to the target voltage, V_target. Optionally, the OTRIM and VTRIM settings are stored in lookup table 906.

Optionally, a disable charge pump regulation mode (which can be referred to as a no regulation mode) can be provided in which charge pump regulators 803 and 903 are disabled in FIGS. 8, 9, and 10. In this mode, VHV=VCP and is free of regulation, meaning that VHV can keep increasing until a junction breakdown (such as a P/N junction breakdown or some other breakdown mechanism) occurs to clamp VHV at a certain level.

FIG. 11A depicts trim configuration method 1100 performed by high voltage generation block 900 and trim configuration circuit 1000 in FIG. 10 to determine settings for OTRIM and VTRIM to store in lookup table 906. I_LOAD is applied as a target current load, and VTRIM is set to VTRIM maximum, or alternatively, a mode is entered where CP regulation is disabled meaning no voltage regulation is performed (1101). OTRIM is set to OTRIM minimum, its minimum value (1102). VHV is measured, and VHV Threshold is set to VHV (1103). OTRIM is incremented, meaning OTRIM is set to next highest OTRIM value (1104). VHV is measured (1105). If VHV>VHV Threshold (1106), (meaning the measured output voltage of the charge pump is greater than the previously-measured output voltage of the charge pump), then VHV Threshold is set to VHV (1107), OTRIM is incremented (1108), and the method returns to operation 1105. If not (1106), then OTRIM is decremented, meaning it is set to the next smallest OTRIM value, and the new OTRIM is stored in lookup table 906 (1109). Basically, trimming configuration method 1100 ends when it finds the optimal point in the output vs. frequency curve (such as shown at the peak in FIG. 7) by continuing to increase the frequency by trimming until it finds a peak is achieved. Trim configuration method 1100 can be operated during configuration of high voltage generation block 900 or during real-time operation of high voltage generation block 900.

FIG. 11B depicts trim configuration method 1120. I_LOAD is applied as a current target load, and OTRIM is set to OTRIM from lookup table 906 (1121), which was previously stored in method 1100 depicted in FIG. 11A. VTRM is set to VTRIM minimum, meaning that the voltage trimming is set at minimum voltage setting (1122). VHV is measured (1123). If VHV=V_target (1124), then VTRIM is stored in lookup table 906 (1126). If not, VTRIM is incremented, meaning VTRIM is set to next highest VTRIM value (1125), and the method returns to operation 1123. Trim configuration method 1120, with out without trim configuration method 1100, can be operated during configuration of high voltage generation block 900 or during real-time operation of high voltage generation block 900.

FIG. 11C depicts trim configuration method 1140. I_LOAD is applied as a load, and VTRIM is set to VTRIM maximum, or alternatively, a mode is entered where CP regulation is disabled meaning no voltage regulation is performed (1141). OTRIM is set to OTRIM minimum, its minimum value (1142). VHV is measured (1143). OTRIM is incremented (1144). VHV is measured (1145). If VHV>V_target+V_margin (1146), then OTRIM is decremented and the new OTRIM is stored in lookup table 906 (1148). If not, OTRIM is incremented (1147), and the method returns to operation 1145. Trim configuration method 1140 can be operated during configuration of high voltage generation block 900 or during real-time operation of high voltage generation block 900.

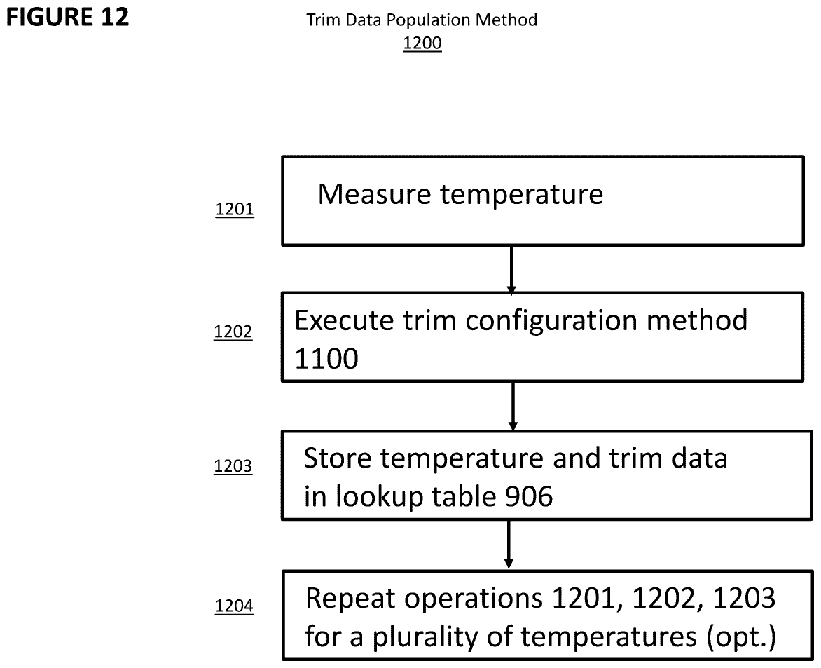

FIG. 12 depicts trim data population method 1200 where trim data is determined and stored in lookup table 906 for one or more temperature values. The temperature is measured (1201). Trim configuration method 1100, 1120, or 1140 of FIG. 11A, 11B, or 11C, respectively, is performed (1202). The measured temperature and the trim data VTRIM and OTRIM are stored in lookup table 906 (1203). Optionally, operations 1201, 1202, and 1203 are repeated for a plurality of temperatures (1204).

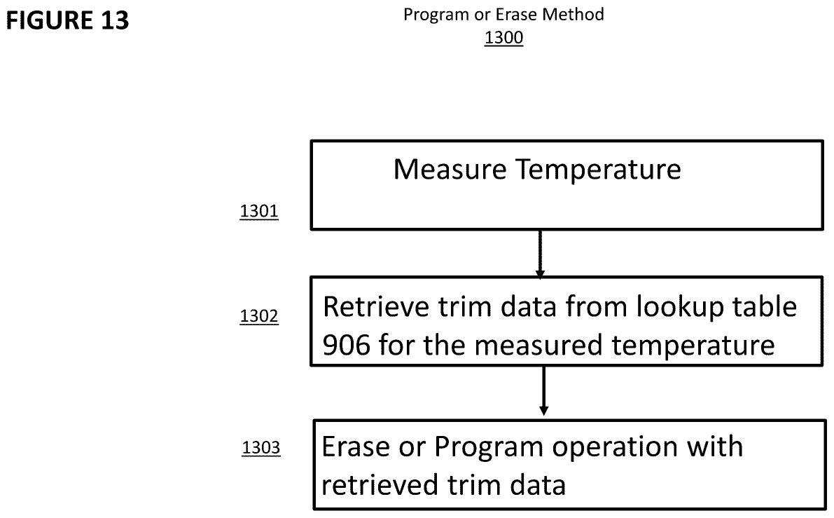

FIG. 13 depicts program or erase method 1300. The temperature is measured (1301). Trim data VTRIM and OTRIM are retrieved from lookup table 906 for the measured temperature (1302). An erase or program operation is performed using the retrieved VTRIM and OTRIM values (1303).

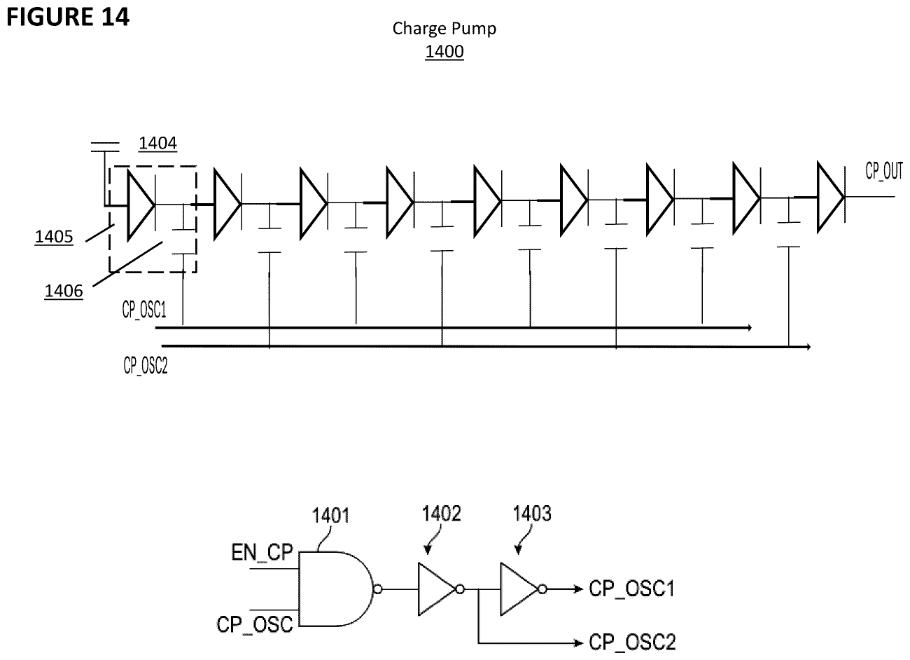

FIG. 14 depicts charge pump 1400. Charge pump 1400 is an example implementation of charge pump 902 in FIGS. 9 and 10. Charge pump 1400 comprises a series of stages such as stage 1404. In this example, charge pump 1400 has 8 stages. Stage 1404 comprises diode 1405 and capacitor 1406. Diode 1405 can be, for example, a Schottky diode, a P/N diode, a MOS-based diode, or other diode. Subsequent stages have the same structure as stage 1404. The pump capacitors, such as pump capacitor 1406, are charged by complementary clock inputs, CP_OSC1 and CP_OSC2. Charge pump 1400 comprises NAND gate 1401 that receives charge pump enable signal, CP_EN, and an output from charge pump oscillator, CP_OSC, which is an oscillating signal from a pump oscillator. The output of NAND gate 1401 is provided to inverter 1402, and the output of inverter 1402 is provided to inverter 1403. The output of inverter 1402 is CP_OSC_2, and the output of inverter 1403 is CP_OSC1 (or vice-versa). CP_OSC1 and CP_OSC2 will have the same frequency as CP_OSC. The voltage output of the charge pump is VOUT=˜(N+1)*(Vdd-VT), where N is number of stages, Vdd is the power supply voltage for the oscillator, and VT is the diode turn-on voltage. The current output of the charge pump is IOUT=˜ C*V*F2, where Fis frequency of the pump oscillator. The charge pump is enabled by signal EN_CP for charge pumping action by the pumping clocks CP_OSC1 and CP_OSC2.

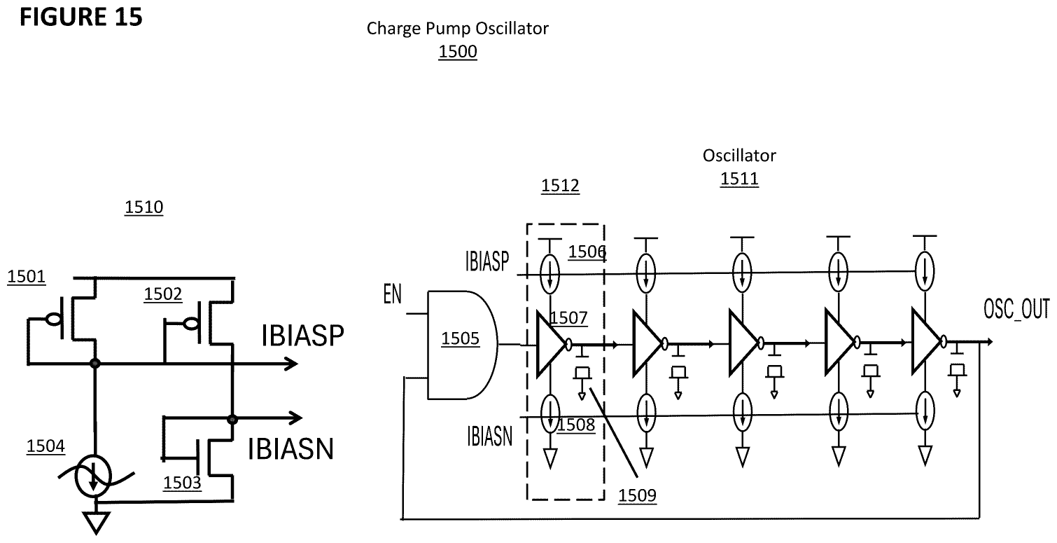

FIG. 15 depicts charge pump oscillator 1500. Charge pump oscillator 1500 is an example implementation of charge pump oscillator 901 in FIGS. 9 and 10. Charge pump oscillator comprises voltage source 1510 and oscillator 1511. Voltage source 1510 comprises PMOS transistors 1501 and 1502, NMOS transistor 1503, and adjustable current source 1504. PMOS transistors 1501 and 1502 form a current mirror and both draw the current drawn by adjustable current source 1504. Bias voltages IBIASP and IBIASN are generated at the nodes shown. Oscillator 1511 receives bias voltages IBIASP and IBIASN. Oscillator 1511 comprises AND gate 1505 and a series of stages such as stage 1512. AND gate 1505 receives an enable signal, EN, and the output of oscillator 1511, OSC_OUT, as its inputs, and the output of AND gate 1505 is provided to the first stage, here stage 1512. Stage 1512 comprises adjustable current source 1506 that is controlled by IBIASP, inverter 1507, capacitor 1509, and adjustable current source 1508 that is controlled by IBIASN. The frequency of the oscillator is determined by delay of the stage 1512, which is determined by the current source 1504 through the IBIASP and IBIASN bias voltages and the capacitor 1509. Hence, by trimming current source 1504, the frequency can be changed faster or slower.

FIG. 16 depict charge pump regulator 1600. Charge pump regulator 1600 is an example implementation of charge pump regulator 903 in FIGS. 9 and 10. Charge pump regulator 1600 comprises divider blocks 1601-1, 1601-2, . . . , 1601-(N−1), 1601-N; multiplexor 1604, reference generator 1610, and comparator 1605. Block 1601-1 comprises diode-connected NMOS transistor 1602-1 and resistor 1603-1. Each of the other blocks 1601-2, . . . 1601-N have the same structure as block 1601. Multiplexor receives inputs from N nodes from each of the N blocks as shown, and receives VTRIM[n:0] as a select signal. Blocks 1601 form a voltage divider, and the N nodes range in voltage between ground and (VHV−N*VDROP), where VDROP is the voltage drop across a single block 1601 and N is number of blocks 1601, corresponding to increasing values of VTRM from its lowest value to its highest value. The node associated with block i among the N blocks is equal to VHV. Reference voltage generator 1610 receives trim bits VTRM[m:0] to trim (adjust) the voltage reference VREF. The node VHV_DIV is the divided HV node after multiplexor 1604. Comparator 1605 compares the voltage VHV_DIV received from multiplexor 1604 against a reference voltage, VREF_TRM, and its output, EN_OSC, will be asserted if (VHV−i*VDROP)<VREF_TRM. An assertion of EN_OSC means the charge pump is enabled to pump. Once (VHV−i*VDROP)<VREF, EN_OSC is deasserted and the charge pump is disabled (meaning no pumping will occur), and therefore, VHV voltage will stay at this level. Hence, both trimbits VTRIM[n:0] and VTRIM[m:0] are used to trim or adjust the VHV level.

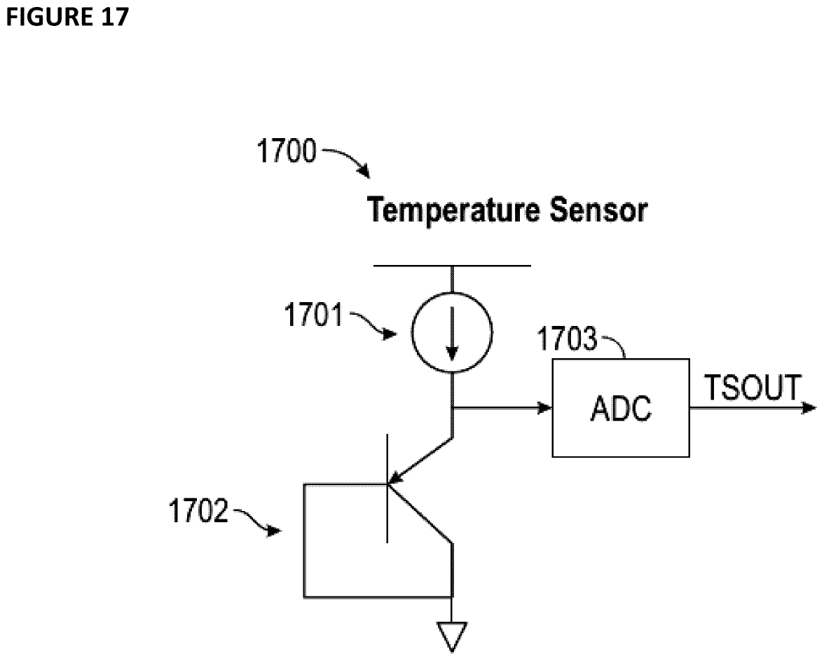

FIG. 17 depicts temperature sensor 1700. Temperature sensor 1700 is an example implementation of temperature sensor 905 in FIGS. 9 and 10. Temperature sensor 1700 comprises current source 1701, bipolar transistor 1702, and analog-to-digital converter (ADC) 1703. VBE (the base-emitter voltage) of bipolar transistor 1702 decreases as temperature increases, which means that the output value, TSOUT, of ADC 1703 decreases as temperature increases. Hence, the ADC output indicates the temperature sensed by temperature sensor 1700.

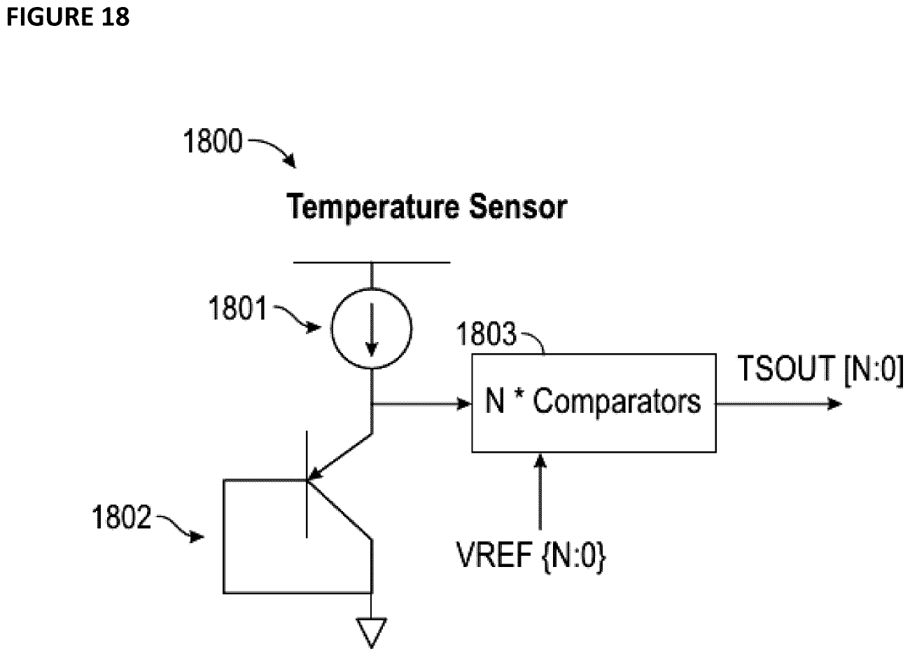

FIG. 18 depicts temperature sensor 1800. Temperature sensor 1800 is an example implementation of temperature sensor 905 in FIGS. 9 and 10. Temperature sensor 1800 comprises current source 1801, bipolar transistor 1802, and comparators 1803. Comparators 1803 comprises one or more comparators that compare the input voltage against a reference voltage and provide an output indicating if the input voltage exceeds the reference voltage. For example, comparators 1803 might comprise three comparators that compare the input voltage against three different reference value VREF1, VREF2, and VREF 3. VBE (the base-emitter voltage) of bipolar transistor 1802 decreases as temperature increases, which means that the three output, TSOUT [2:0], will change as the input drops below each of the reference voltages to indicate which temperature has been reached.

As used herein, the terms “over” and “on” both inclusively include “directly on” (no intermediate materials, elements or space disposed therebetween) and “indirectly on” (intermediate materials, elements or space disposed therebetween). Likewise, the term “adjacent” includes “directly adjacent” (no intermediate materials, elements or space disposed therebetween) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements therebetween, as well as forming the element indirectly on the substrate with one or more intermediate materials/elements there between.

What is claimed is:

1. A high voltage generation block comprising:
a temperature sensor to sense an operating temperature and output a temperature output;
a trim circuit to receive a trim enable circuit and the temperature output and to generate oscillator trim bits;
a charge pump oscillator to generate an oscillating signal in response to the oscillator trim bits and a feedback signal;
a charge pump to receive the oscillating signal and to generate a pumped voltage; and
a charge pump regulator to receive the pumped voltage and to generate the feedback signal and a high voltage output.

2. The high voltage generation block of claim 1, wherein the charge pump regulator receives voltage trim bits and where the pumped voltage is altered in response to the voltage trim bits to generate the high voltage output.

3. The high voltage generation block of claim 1, wherein the trim circuit comprises a lookup table that outputs the oscillator trim bits in response to the temperature output.

4. The high voltage generation block of claim 1, wherein the trim circuit comprises a lookup table that outputs the oscillator trim bits and the voltage trim bits in response to the temperature output.

5. A method comprising:
setting an oscillator trim value to a first initial value;
setting a voltage trim value to a second initial value;
applying the oscillator trim value and a voltage trim value to a high voltage generation block comprising a charge pump;
measuring a voltage output from the charge pump;
if the voltage output is not at a target voltage, incrementing the voltage trim value and repeating the applying and measuring;
if the voltage output is at the target voltage, setting the oscillator trim value to the voltage trim value;
measuring a voltage output from the charge pump.
if the voltage output is not at a target voltage, incrementing the oscillator trim value and repeating the applying and measuring; and
if the voltage output is at the target voltage, storing the voltage trim value and the oscillator trim value.

6. The method of claim 5, wherein the storing comprising storing the voltage trim value and the oscillator trim value in a lookup table.

7. The method of claim 5, wherein the method is performed for multiple temperature values and the temperature values are stored with respective a voltage trim value and an oscillator trim value.

8. The method of claim 7, wherein the storing comprises storing the temperature values and respective voltage trim value and the oscillator trim value in a lookup table.

9. The method of claim 5, comprising retrieving the voltage trim value and the oscillator trim value and using the voltage trim value and oscillator trim value during a program or erase operation.

10. A method comprising;
trimming, using oscillator trim bits, a frequency of a charge pump oscillator until an output of the charge pump receiving an oscillating signal from the charge pump oscillator reaches a peak value; and
storing the oscillator trim bits.

11. The method of claim 10, comprising:
retrieving the oscillator trim bits;
using the oscillator trim bits to trim the charge pump oscillator; and
generating, by the charge pump, an output voltage in response to an oscillating signal from the charge pump oscillator.

12. The method of claim 11, comprising:
applying the output voltage to an array of non-volatile memory cells to perform a program operation.

13. The method of claim 11, comprising:
applying the output voltage to an array of non-volatile memory cells to perform an erase operation.

14. The method of claim 10, comprising:
retrieving the oscillator trim bits;
using the oscillator trim bits to trim the charge pump oscillator at a first temperature; and
generating, by the charge pump, an output voltage in response to an oscillating signal from the charge pump oscillator.

15. The method of claim 10, comprising:
retrieving the oscillator trim bits;
using the oscillator trim bits to trim the charge pump oscillator at a second temperature; and
generating, by the charge pump, an output voltage in response to an oscillating signal from the charge pump oscillator.

16. The method of claim 10, comprising:
repeating the trimming and the storing at a plurality of operating temperatures.

17. The method of claim 16, comprising:
measuring an operating temperature; and
retrieving oscillator trim bits associated with the measured operating temperature.

18. The method of claim 16, comprising:
measuring an operating temperature; and
retrieving oscillator trim bits associated with a range of operating temperatures that includes the measured operating temperature.

19. The method of claim 10, comprising:
trimming, using voltage trim bits, a voltage of a charge pump until an output of the charge pump is equal to a target voltage; and
storing the voltage trim bits.

20. The method of claim 19, comprising:
retrieving the voltage trim bits;
using the voltage trim bits to trim the charge pump at a first temperature; and
generating, by the charge pump, an output voltage in response to the voltage trim bits.

21. The method of claim 19, comprising:
retrieving the voltage trim bits;
using the voltage trim bits to trim the charge pump at a second temperature; and
generating, by the charge pump, an output voltage in response to the voltage trim bits.

22. The method of claim 19, comprising:
repeating the voltage trimming and the storing of voltage trim bits at a plurality of operating temperatures.

23. The method of claim 22, comprising:
measuring an operating temperature; and
retrieving voltage trim bits associated with the measured operating temperature.

24. The method of claim 22, comprising:
measuring an operating temperature; and
retrieving voltage trim bits associated with a range of operating temperatures that includes the measured operating temperature.

25. A method comprising:
sensing a temperature,
trimming a frequency of a signal generated by a charge pump oscillator in response to the temperature.

26. The method of claim 25, comprising:
generating, by a charge pump, a pumped voltage in response to the signal generated by the charge pump oscillator.

27. The method of claim 26, comprising:
generating, by a charge pump regulator, a high voltage in response to the pumped voltage.

28. The method of claim 27, comprising:
applying the high voltage to a memory cell during an erase operation.

29. The method of claim 27, comprising:
applying the high voltage to a memory cell during a program operation.
